(19) United States
(12) Patent Application Publication
(10) Pub. No.: US 2015/0253909 A1
(43) Pub. Date: Sep. 10, 2015

(54) TOUCH SENSOR

(71) Applicant: SAMSUNG ELECTRO-MECHANICS CO., LTD., Gyeonggi-Do (KR)

(72) Inventors: Gyu Seok KIM, Gyeonggi-Do (KR); Hee Suk CHUNG, Gyeonggi-Do (KR); Dong Yong KIM, Gyeonggi-Do (KR); Dek Gin YANG, Gyeonggi-Do (KR); Mi Yang KIM, Gyeonggi-Do (KR); Tae Young KIM, Gyeonggi-Do (KR)

(73) Assignee: SAMSUNG ELECTRO-MECHANICS CO., LTD., Gyeonggi-Do (KR)

(21) Appl. No.: 14/341,096

(22) Filed: Jul. 25, 2014

(30) Foreign Application Priority Data
Mar. 4, 2014 (KR) 10-2014-0025703

(51) Int. Cl. G06F 3/047

(52) U.S. Cl. CPC G06F 3/047

(57) ABSTRACT

Embodiments of the invention provide a touch sensor including a base substrate, and an electrode pattern formed on the base substrate. The electrode pattern is formed by continuously connecting one or more unit patterns, and each unit pattern has closed figures formed to be irregularly arranged therein.

### CROSS REFERENCE TO RELATED APPLICATION

PIM This application claims the benefit of and priority under 35 U.S.C. §119 to Korean Patent Application No. KR 10-2014-0025703, entitled “TOUCH SENSOR,” filed on Mar. 4, 2014, which is hereby incorporated by reference in its entirety into this application.

### BACKGROUND

1. Field of the Invention

The present invention relates to a touch sensor.

2. Description of the Related Art

In accordance with the growth of computers using a digital technology, devices assisting computers have also been developed, and personal computers, portable transmitters and other personal information processors execute processing of text and graphic using variety of input devices, such as a keyboard and a mouse.

In accordance with the rapid advancement of an information-oriented society, the use of computers has gradually been widened. However, it is difficult to efficiently operate products using only the keyboard and the mouse as the primary input devices. Therefore, the necessity for a device that is simple, has minimum malfunction, and is capable of easily inputting information has increased.

In addition, techniques for input devices have progressed toward techniques related to high reliability, durability, innovation, designing and processing beyond a Level of satisfying general functions. To this end, a touch sensor has been developed as an input device capable of inputting information, such as text or graphics, as non-limiting examples.

The conventional touch sensor is mounted, for example, on a display surface of a display, such as an electronic organizer, a flat panel display device including a liquid crystal display (LCD) device, a plasma display panel (PDP), or an electroluminescence (El) element, or a cathode ray tube (CRT), as non-limiting examples, to thereby be used to allow a user to select desired information while viewing the display.

In addition, the conventional touch sensor is classified into a resistive-type touch sensor, a capacitive-type touch sensor, an electromagnetic-type touch sensor, a surface acoustic wave (SAW)-type touch sensor, and an infrared-type touch sensor. These various types of touch sensors are adopted for electronic products in consideration of a signal amplification problem, a resolution difference, a level of difficulty of designing and processing technologies, optical characteristics, electrical characteristics, mechanical characteristics, environment resistance, input characteristics, durability, and economic efficiency. Currently, the resistive type touch sensor and the capacitive type touch sensor have been prominently used in a wide range of fields.

Traditionally, according to U.S. Patent Application Publication No. 2012/0062510, in the case in which a mesh pattern is used as an electrode pattern of the touch sensor, a moiré phenomenon caused by a regular mesh shape may occur. The above-mentioned moiré phenomenon allows a user to recognize the electrode pattern of the touch sensor to thereby degrade an entire visibility of the touch sensor. Further, since the moiré phenomenon caused by a regular metal pattern forming the mesh pattern influences the entire visibility of the touch sensor, it may degrade definition of an image output from a display and a related output image or reliability of other images.

### SUMMARY

Accordingly, embodiments of the invention have been made to provide a touch sensor capable of improving visibility of the touch sensor by preventing a moiré phenomenon, which occurs from an intersection between electrode patterns or a relationship with a black matrix of a display by forming irregular (random) mesh patterns through a combination of unit patterns including an irregular closed figure.

According to an embodiment of the invention, there is provided a touch sensor including a base substrate, and an electrode pattern formed on the base substrate, wherein the electrode pattern is formed by continuously connecting one or more unit patterns and the unit pattern has closed figures formed to be irregularly arranged therein.

According to an embodiment, the unit pattern is harmed by irregularly arranging one or more closed figures formed in a polygonal shape.

According to an embodiment, the number of vertexes of the closed figures in the unit pattern is different from the number of vertexes of quadrangles having the same number as the closed figures.

According to an embodiment, the unit pattern includes one or more metal fine wires for electrical connection between the unit patterns adjacent to each other.

According to another embodiment of the invention, there is provided a touch sensor including a base substrate, and an electrode pattern formed on the base substrate, wherein the electrode pattern is formed by continuously connecting one or more unit patterns and the unit pattern has closed figures formed to be irregularly arranged therein, and the unit pattern is formed by including one or more metal tine wires forming the closed figures and edge sides surrounding the metal tine wires and electrically connecting the metal fine wires between the unit patterns adjacent to each other.

According to an embodiment, the electrode pattern is formed by continuously connecting two or more unit patterns having closed figures different from each other.

According to an embodiment, the electrode pattern is formed by continuously connecting two or more unit patterns having the same closed figures.

According to an embodiment, the unit patterns are formed by forming one or more connection points to which the metal fine wires and the edge sides are connected at the edge sides and electrically connecting the metal fine wires through the corresponding connection points between the unit patterns adjacent to each other.

According to an embodiment, the unit patterns have the connection points to which the metal fine wires and the edge sides are connected, formed at center points of the edge sides.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a view showing a touch sensor according to an embodiment of the invention.

FIGS. 2(A) and 2(B) are views showing electrode patterns of the touch sensor according to an embodiment of the invention.

FIG. 3 is a view showing a moiré phenomenon, which occurs from an electrode pattern formed in a regular mesh pattern according to the conventional art.

FIGS. 4(A)-(C) are views showing an irregular mesh pa coupled by unit patterns having the same closed figures according to an embodiment of the invention.

FIGS. 5(A)-(C) and 6(A)-(C) are views showing an irregular mesh pattern coupled by unit patterns having different closed figures according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described detail with reference to the accompanying drawings.

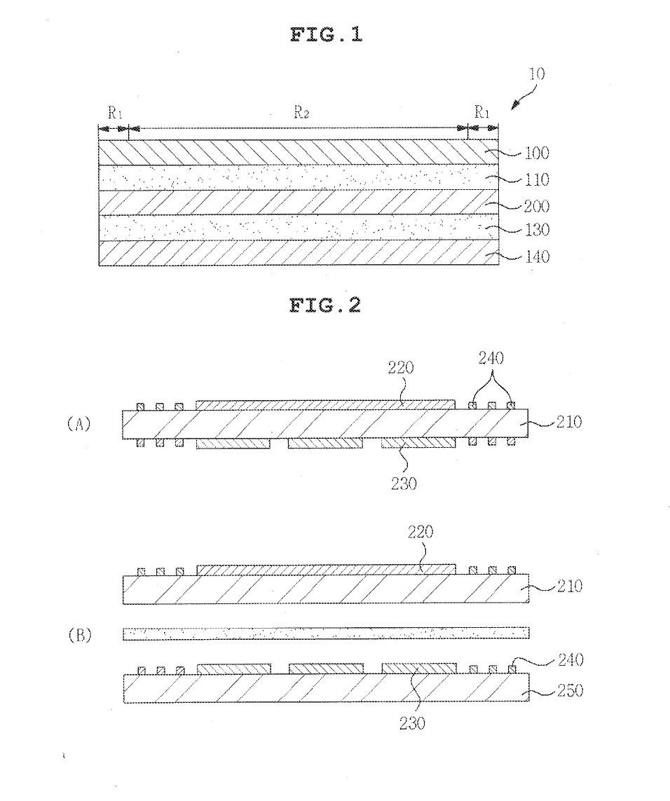

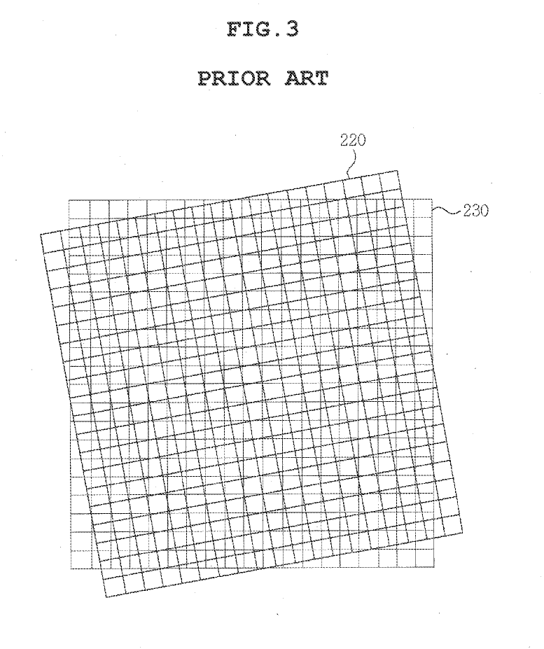

FIG. 1 is a view showing a touch sensor according to an embodiment of the invention, and FIGS. 2(A) and 2(B) are views showing electrode patterns of the touch sensor according to an embodiment of the invention. A touch sensor 10 according to an embodiment of the invention includes a window substrate 100, electrode patterns 220 and 230 formed on base substrates 210 and 250, a sensor module 200 adhered to be opposite to the window substrate 100, and a display module 140 displaying an output value for an input of a user by the touch sensor 10 and adhered to one surface of the touch sensor 10.

According to an embodiment, the window substrate 100 includes a central region R2 and edge regions R1 surrounding the central region R2, are disposed at the outermost portion of the touch sensor 10 to receive a touch from the user, and are formed, for example, of a tempered glass to serve as a protection layer. Since the window substrate 100 has a bezel part (not shown) and the electrode patterns 121 and 122 are formed on a rear surface thereof, a surface treatment layer (not shown) is formed by performing, for example, high frequency treatment or primer treatment on the rear surface of the window substrate 100 to improve adhesion between the window substrate 100 and the bezel part (not shown) or the electrode patterns 121 and 122.

According to an embodiment, the sensor module 200 includes base substrates 210 and 250, electrode patterns 220 and 230 formed on the base substrates 210 and 250, and electrode wires 240 formed at one end of the electrode patterns 220 and 230 to transfer an electrical signal.

According to an embodiment, the base substrates 210 and 250 are made of any material, which has a predetermined strength or more and is transparent to allow an image of the display module 140 to be output. For example, the base substrates 210 and 250 are made, for example, of polyethylene terephthalate (PET), polycarbonate (PC), poly methyl methacrylate (PMMA), polyethylene naphthalate (PEN), polyethersulfone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass, but are not necessarily limited thereto. In addition, since the electrode patterns 220 and 230 are formed on one surface of the base substrates 210 and 250, the surface treatment layer is formed by performing, for example, high frequency treatment or primer treatment, as non-limiting examples, on one surface of the base substrates 210 and 250 to improve adhesion between the base substrates 210 and 250 and the electrode patterns 220 and 230.

According to an embodiment, the sensor module 200 includes, but is not limited to, i) first electrode patterns 220 formed in one direction to be in parallel with each other on one surface of the base substrate 210 and second electrode patterns 230 formed in one direction intersecting with the first electrode patterns 220 to be in parallel with each other on the other surface of the base substrate 210 (see FIG. 2(A)), ii) first electrode patterns 220 formed in one direction to be in parallel with each other on one surface of the first base substrate 210 and second electrode patterns 230 formed in a direction intersecting with the first electrode patterns 220 to be in parallel with each other on one surface of the second base substrate 250 (see FIG. 2(B)), and iii) the electrode wires 240 electrically connected to one end of the first and second electrodes 220 and 230.

According to an embodiment, the first and second electrode patterns 220 and 230 generate a signal by an input unit of a touch to recognize a touch coordinate from a controlling unit (not shown) and are formed by continuously connecting one or more unit patterns 221, 222, and 223, wherein closed FIGS. 221c, 222c, and 223c are irregularly arranged in the unit patterns 221, 222, and 223.

Although FIGS. 2(A) and 2(B) show a case in which the first electrode pattern 220 and the second electrode pattern 230 have a bar pattern, embodiments of the invention is not limited thereto.

According to an embodiment, the first and second electrode patterns 220 and 230 are formed, for example, by a dry process, a wet process, or a direct patterning process, as non-limiting examples. According to an embodiment, the dry process include, for example, a sputtering process or an evaporation process, as non-limiting examples, the wet process includes, for example, a dip coating process, a spin coating process, a roll coating process, or a spray coating process, as non-limiting examples, and the direct patterning process includes, for example, a screen printing process, a gravure printing process, or an inkjet printing process, as non-limiting examples.

According to an embodiment, the first and second electrode patterns 220 and 230 are irregular (random) mesh patterns formed by continuously connecting one or more unit patterns, wherein one or more closed figures formed in a polygonal shape are irregularly arranged on the unit pattern and the number of vertexes of the closed figures are different from the number of vertexes of quadrangles having the same number as the closed figures. According to an embodiment, the unit pattern includes one or more metal fine wires 221a, 222a, and 223a for electrical connection between the unit patterns adjacent to each other, wherein the metal fine wires 221a, 222a, and 223a are formed using copper (Cu), aluminum (Al), gold (Au), silver (Ag), titanium (Ti), palladium (Pd), chromium (Cr), nickel (Ni), or a combination thereof, detailed description thereof will be provided below.

According to an embodiment, adhesive layers 110 and 130 attach components of the touch sensor 10 to each other. As a material of the adhesive layer, a transparent material is used so as not to interfere with recognition by a user of an image output through the display module 140 and an optical clear adhesive (OCA) is used, for example.

According to an embodiment, the-display module 140 is adhered to one surface of the touch sensor 10 by the adhesive layer 110 and 130. The display module 140, which is a display device capable of visually outputting data on a screen, mainly includes, but is not necessarily limited to, a cathode ray tube (CRT), a liquid crystal display (LCD), a plasma display panel (PDP), a light emitting diode (LED), or an organic light emitting diode (OLED), as non-limiting examples.

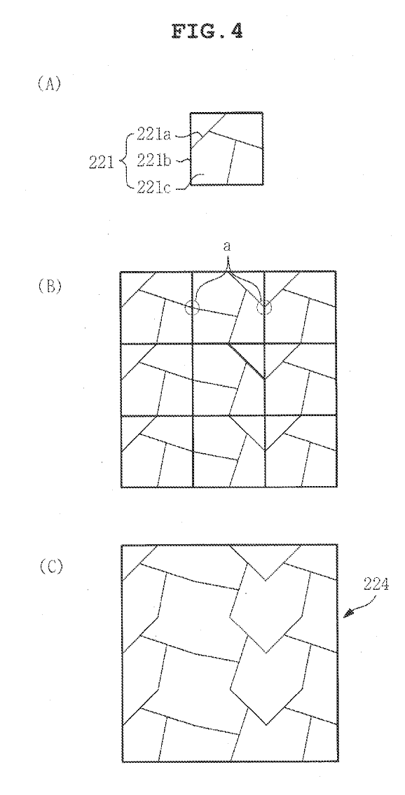

Hereinafter, the unit pattern configuring the electrode pattern of the touch sensor according to various embodiments of the invention will be described in more detail with reference to FIGS. 3 to 6. Hereinafter, the unit pattern may refer to unit patterns configuring the irregular (random) mesh pattern, a edge side may refer to a line surrounding an edge of the unit pattern, and the closed figure may refer to a polygon, formed by the metal fine wire and the edge side in the unit pattern, but they are not limited thereto.

In addition, the first and second electrode patterns may include the unit pattern having the same structure. Therefore, the following description will be based on the unit pattern configuring the first electrode pattern.

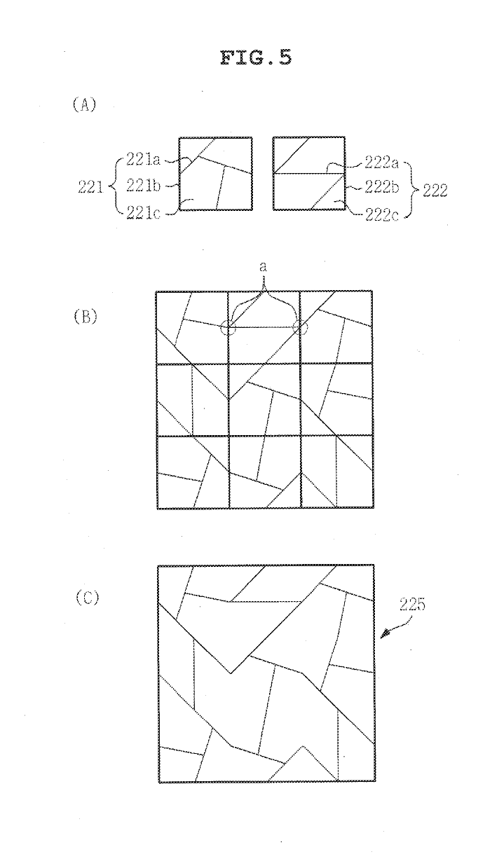

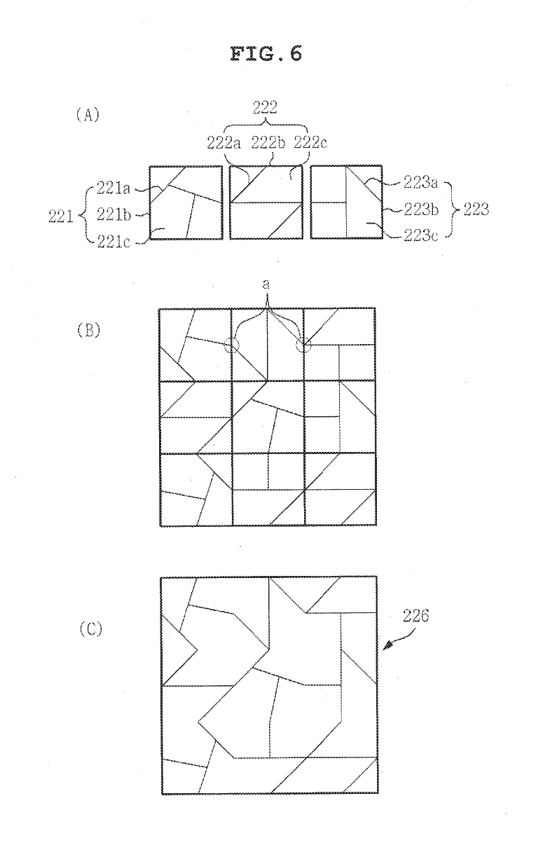

FIG. 3 is a view showing a moiré, phenomenon, which occurs from an electrode pattern formed in a regular mesh pattern according to the conventional art, FIGS. 4(A)-(C) are views showing an irregular mesh pattern coupled by unit patterns having the same closed figure according to an embodiment of the invention, and FIGS. 5(A)-(C) and 6(A)-(C) are views showing an irregular mesh pattern coupled by unit patterns having different closed figures according to an embodiment of the invention.

It will be appreciated by one of ordinary skill in the relevant art from FIG. 3, which is the general mesh pattern according to the conventional art, that when two patterns having a regular arrangement are formed to be inclined to each other, a moiré phenomenon is visually detected. The moiré phenomenon refers to a phenomenon in which a moiré is generated everywhere in the case in which patterns having a predetermined interval are repeatedly overlapped. When the above-mentioned moiré phenomenon occurs on the electrode patterns 220 and 230 of the touch sensor, the mesh pattern made of an opaque metal material is prominently recognized by the user to thereby decrease visibility of the touch sensor, such that visibility of the image output from the display unit 140 coupled to the touch sensor 10 is also influenced.

Therefore, the electrode patterns 220 and 230 of the touch sensor 10 according to an embodiment of the invention are formed by continuously connecting one or more unit patterns 221, 222, and 223 to each other, the closed FIGS. 221c, 222c, and 223c are formed to be irregularly arranged in the unit patterns 221, 222, and 223, and the unit patterns 221, 222, and 223 are formed by including one or more metal fine wires 221a, 222a, and 223a forming the closed FIGS. 221c , 222c, and 223c and edge sides 221b, 222b, and 223b surrounding the metal fine wires 221a, 222a, and 223a, and electrically connecting the metal fine wires 221a, 222a, and 223a to each other between the unit patterns 221, 222, and 223 adjacent to each other.

According to an embodiment, the electrode patterns 220 and 230 are formed by continuously connecting two or more unit patterns 221, 222, and 223 having the closed FIGS. 221c, 222c, and 223c different from each other (see FIGS. 5(A)-(C) and 6(A)-(C)) and are formed by continuously connecting two or more unit patterns 221 having the same closed FIGS. 221c, 222c, and 223c (see FIGS. 4(A)-(C)) and the unit patterns 221, 222, and 223 are formed by forming one or more connection points a to which the metal fine wires 221a, 222a, and 223a and the edge sides 271b, 222b, and 223b are connected at the edge sides 221b, 222b, and 223b and electrically connecting the metal fine wires 221a, 222a, and 223a to each other through the corresponding connection points a between the unit patterns 221, 222, and 223 adjacent to each other. According to an embodiment, the unit patterns 221, 222, and 223 have connection points a to which the metal fine wires 221a, 222a, and 223a and the edge sides 221b, 222b, and 223b are connected, formed at center points of the edge sides 221b, 222b, an 223b.

Thus, as shown in FIGS. 4(A)-(C), the electrode patterns 220 and 230 of the touch sensor 10 according, to an embodiment of the invention are formed by continuously connecting two or more first unit patterns 221 having the same closed FIG. 221c, wherein the first unit pattern 221 include one or more metal fine wires 221a forming the closed FIG. 221c and the edge side 221b surrounding the metal fine wires 221a.

According to an embodiment, the edge side 221b of the first unit pattern 221 is provided with the connection points a to which the metal fine wire 221a and the edge side 221b are connected, the metal fine wire 221a is electrically connected between the first unit patterns 221 adjacent to each other through the corresponding connection point a, and the connection point a is formed at the center point of the edge side 221b.

Therefore, the electrode patterns 220 and 230 of the touch sensor 10 according to an embodiment of the invention is formed in the irregular (random) mesh pattern 224 having various forms in which the first unit patterns 221 having the same closed FIG. 221c are electrically connected to each other, wherein the first unit patterns 221 are not limited to the scheme shown in FIGS. 4(A)-(C), but are coupled to each other in various schemes.

In addition, as shown in FIGS. 5(A)-(C), the electrode patterns 220 and 230 of the touch sensor 10 according to an embodiment of the invention are formed by continuously connecting two or more first unit patterns 221 and second unit patterns 222 having the closed FIG. 221c or 222c different from each other, wherein the first unit pattern 221 and the second unit pattern 222 include one or more metal fine wires 221a or 222a forming the closed FIG. 221c or 222c and the edge side 221b or 222b surrounding the metal fine wires 221a or 222a.

According to an embodiment, the edge side 221b or 222b of the first unit pattern 221 and the second unit pattern 222 are provided with the connection point a to which the metal tine wire 221a or 222a and the edge side 221b or 222b are connected, the metal fine wire 221a or 222a is electrically connected between the first unit pattern 221 and the second unit pattern 222 adjacent to each other through the corresponding connection point a, and the connection point a is formed at the center point of the edge side 221b or 222b.

Therefore, the electrode patterns 220 and 230 of the touch sensor 10 according to an embodiment of the invention is formed in an irregular (random) mesh pattern 225 having various forms in which the first unit patterns 221 and the second unit pattern 222 having the closed FIG. 221c or 222c different from each other are electrically connected to each other, wherein the first unit pattern 221 and the second unit pattern 222 are not limited to the scheme shown in FIGS. 5(A)-(C), but are coupled to each other in various schemes.

Further, as shown in FIGS, 6(A)-(C), the electrode patterns 220 and 230 of the touch sensor 10 according to an embodiment of the invention are formed by continuously connecting two or more first to third unit patterns 221, 222, and 223 having the closed FIGS. 221c to 223c different from each other, wherein the first to third unit patterns 221, 222, and 223 include one or more metal fine wires 221a to 223a forming the closed FIGS. 221c to 223c and the edge sides 221b to 223b surrounding the metal tine wires 221a to 223a.

According to an embodiment, the edge sides 221b to 223b of the first to third unit patterns 221, 222, and 223 are provided with the connection points a to which the metal fine wires 221a to 223a and the edge sides 221b to 223b are connected, the metal fine wires 221a to 223a are electrically connected between the first unit pattern to the third unit pattern 221, 222, and 223 adjacent to each other through the corresponding connection points a, and the connection point a is formed at the center point of the edge sides 221b to 223b.

Therefore, the electrode patterns 220 and 230 of the touch sensor 10 according to an embodiment of the invention is formed in an irregular (random) mesh pattern 226 having various forms in which the first to third unit patterns 221, 222, and 223 having the closed FIGS. 221c to 223c different from each other is electrically connected to each other, wherein the first to third unit patterns 221, 222, and 223 are not limited to the scheme shown in FIGS. 6(A)-(C), but are coupled to each other in various schemes.

According to the various embodiments of the invention, the entire visibility of the touch sensor is improved by mitigating the recognition of the electrode pattern by the user.

In addition, the visibility of the electrode pattern is decreased by preventing the moiré phenomenon which occurs between the metal mesh patterns, thereby making it possible to improve the entire visibility of the touch sensor.

In addition, the definition of the image output from the display unit is further improved by preventing the moiré phenomenon which occurs by the overlap of the black matrix and the electrode pattern on the display unit coupled to the touch sensor, in advance.

In addition, the electrode pattern of the touch sensor according to various embodiments of the invention simplifies the process of forming the electrode pattern having the large area and shorten the processing time by being formed in the irregular (random) mesh pattern through the continuous connection of the unit patterns having the closed polygonal figures irregularly arranged thereon, and improves the visibility of the electrode pattern by the irregular mesh patterns which have the uniform size distribution and are not overlapped with each other.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,”and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a base substrate; and
an electrode pattern formed on the base substrate,
wherein the electrode pattern is formed by continuously connecting one or more unit patterns, and
wherein each unit pattern has closed figures formed to be irregularly arranged therein.

2. The touch sensor as set forth in claim 1, wherein the unlit pattern is formed by irregularly arranging one or more closed figures formed in a polygonal shape.

3. The touch sensor as set forth in claim 2, wherein a number of vertexes of the closed figures in the unit pattern is different from the number of vertexes of quadrangles having the same number as the closed figures.

4. The touch sensor as set forth in claim 1, wherein the unit pattern comprises one or more metal fine wires for electrical connection between the unit patterns adjacent to each other.

5. A touch sensor, comprising;
a base substrate; and
an electrode pattern formed on the base substrate,
wherein the electrode pattern is formed by continuously connecting one or more unit patterns,
wherein each unit pattern has closed figures formed to be irregularly arranged therein, and
wherein the unit pattern is formed by including one or more metal fine wires forming the closed figure and edge sides surrounding the metal fine wires and electrically connecting the metal fine wires between the unit patterns adjacent to each other.

6. The touch sensor as set formed in claim 5, wherein the electrode pattern is formed by continuously connecting two or more unit patterns having closed figures different from each other.

7. The touch sensor as set forth in claim 5, wherein the electrode pattern is formed by continuously connecting two or more unit patterns having the same closed figures.

8. The touch sensor as set forth in claim 5, wherein the unit patterns are formed by forming one or more connection points to which the metal fine wires and the edge sides are connected at the edge sides and electrically connecting the metal fine wires through the corresponding connection points between the unit patterns adjacent to each other.

9. The touch sensor as set forth in claim 8, wherein the unit patterns have the connection points to which the metal fine wires and the edge sides are connected, formed at center points of the edge sides.
